(19) United States
(12) Patent Application Publication
(10) Pub. No.: US 2020/0039072 A1
(43) Pub. Date: Feb. 6, 2020

(54) APPARATUS FOR ANALYSING MOVEMENT AND DRIVE APPARATUS

(71) Applicant: PHYSIK INSTRUMENTE (PI) GMBH & CO. KG, Karlsruhe (DE)

(72) Inventors: Erik Mankin, Karlsruhe (DE); Christian Müllerleihe, Karlsruhe (DE); Christian Rudolf, Karlsbad (DE)

(21) Appl. No.: 16/484,537

(22) PCT Filed: Feb. 21, 2018
(86) PCT No.: PCT/EP2018/054245

§ 371 Date: Aug. 8, 2019

(30) Foreign Application Priority Data
Mar. 2, 2017 (DE) 10 2017 104 335.7

(51) Int. Cl. B25J 9/16; G05B 19/404; G05B 13/04

(52) U.S. Cl. CPC B25J 9/1664; G05B 19/404; G05B 13/042; G05B 2219/50162; B25J 9/1653; G05B 2219/36174; G05B 2219/39194; B25J 9/1671

(57) ABSTRACT

The invention relates an apparatus for analysing movement of an arrangement made of a plurality of bodies assigned to a platform, of which at least one is provided with a drive, in particular of the hexapod type or of the articulated arm type, having means for vibration analysis and/or force analysis. According to the invention, the apparatus has in a modular construction a vibration analysis module for analytically determining natural vibration modes of the bodies and/or of the platform in respect of at least one of the following variables: frequency, centre of rotation of the torsional component of the vibrations, axis of rotation of torsional vibration, displacement vector of a Cartesian vibration, amplitude ratio of the vibrations in relation to one another, and/or a force analysis module for analytically determining the acceleration forces and/or weights and/or torques, occurring on a predetermined trajectory, in respect of the bodies and/or the platform.

The invention relates to an apparatus for analysing movement of an arrangement comprising a plurality of bodies assigned to a platform, of which at least one is provided with a drive, in particular of the hexapod type or of the articulated-arm type, having means for vibration analysis and/or force analysis, as well as a drive apparatus of such an arrangement, a machining arrangement having such a drive apparatus and a simulation for the movement path simulation of an arrangement of the said type. The invention further relates to a method for analysing movement of an arrangement comprising a plurality of bodies assigned to a platform, of which at least one is provided with a drive, in particular of the hexapod type or of the articulated-arm type, as well as a drive control method of a corresponding arrangement comprising such a method, a control method of a machining arrangements and finally a simulation method for simulating the movement paths of an arrangement of the said type.

An electric motor, in particular a piezo-based linear motor can be provided as a drive and the machining arrangement can comprise a machine tool or an industrial robot.

Arrangements of the type mentioned here and processing machines and systems based thereon are increasingly being used in computer-assisted production processes. Their implementation requires ensuring a high positioning accuracy and as far as possible eliminating collisions, even in a complex and trouble-prone fabrication environment. The corresponding requirements increase substantially with the complexity of these systems and the shortening of the cycle times. Corresponding movement analysis apparatus and methods have therefore been the subject of comprehensive developments in the last few years. For example, reference is made to EP 1 403 746 B1, EP 1 980 374 A2 or EP 2 954 986 A1 for the prior art created there.

The object of the present invention consists in providing a further improved generic apparatus for analysing movement, an improved method for analysing movement of a generic arrangement and a drive apparatus based on this or simulation arrangement or a drive method or simulation method,which in particular ensure a better adaptability to various usage situations which change during operation.

This object is solved in its central apparatus aspect by an apparatus having the features of claim 1 and in its central method aspect by a method having the features of claim 11. Expedient further developments of the invention are the subject matter of the back-related claims.

The invention includes the idea of constructing the apparatus for analysing movement in a modular fashion and specifically with a vibration analysis module for analytical determination of natural vibration modes of the bodies and/or the platform with regard to at least one of the following variables: frequency, centre of rotation of the torsional component of the vibrations, axis of rotation of a torsional vibration, displacement vector of a Cartesian vibration, amplitude ratio of the vibrations with respect to one another and/or a force analysis module for analytical determination of the acceleration forces and/or weights and/or torques, occurring on a predetermined trajectory with respect to the body and/or the platform.

In one embodiment, the vibration analysis module and/or the force analysis module is configured for vibration or force analysis based on inertial point masses.

In a further embodiment, the vibration analysis module is configured for analytical determination of the natural vibrations of hexapods and the force analysis module is configured as a leg load module for analytical determination of the leg loads or forces of the legs of hexapods.

In a further expedient embodiment, the vibration analysis module is configured for analytical determination of the natural vibrations of an articulated arm and the force analysis module is configured as an articulated load module for determining the articulated loads or forces of the articulations of an articulated arm.

Furthermore, a drive apparatus of an arrangement of the type in question is provided, the analysis and control means of which comprise an apparatus of the type according to the invention explained above and are configured for a force analysis before starting a movement sequence and/or for analysing movement during a movement sequence of the body.

In one embodiment of this drive apparatus, the analysis and control means comprises a load change modelling unit which is connected on the input side to the force analysis module and optionally to the vibration analysis module and is configured for modelling a load case change as a result of a corresponding input by a user or automatically in the event of a load change in the arrangement. In one embodiment a load change can be assigned to a specific known load change type as a result of a registration of the actually applied drive force or its time dependence.

A further approach to load change detection consists in identifying unknown loads on the basis of forces applied or transmitted by the drive elements during a movement sequence and initiating a modelling, by for example, determining relevant inertia datasets.

In a further embodiment of the drive apparatus, the analysis and control means comprises a storage unit for storing pre-calculated parameter tables in the manner of lookup tables or specifications for determining variable control parameters and a movement path correction unit connected to the storage unit for executing movement path corrections during the movement sequence of the bodies as a result of the pre-calculated and stored parameter tables.

In a particularly attractive embodiment in practice, the drive apparatus is configured as the drive apparatus of a parallel or hybrid robot with at least one articulated arm which encloses a controller which is connected to outputs of the vibration analysis module and the force analysis module and in which a controller parametrization is implemented as a result of output data of these modules.

With such a drive apparatus which is used to move a tool relative to a workpiece, a machining arrangement, in particular an arrangement comprising a machine tool or an industrial robot, can be constructed in an advantageous manner.

Within the framework of the invention, furthermore a simulation arrangement for simulation of the movement paths of an arrangement of the type specified previously is provided, which processes output values of the vibration analysis module and the force analysis module for simulation of movement paths and if desired an allowed movement space of the body or the platform with assigned bodies.

Under method aspects, the invention includes the concept of a movement analysis involving an analytical determination of natural vibration modes of the bodies and/or the platform with regard to at least one of the following variables: frequency, centre of rotation of the torsional component of the vibrations, axis of rotation of a torsional vibration, displacement vector of a Cartesian vibration, amplitude ratio of the vibrations with respect to one another in a vibration analysis module as well as an analytical determination of the acceleration forces and/or weights and/or torques, occurring on a predetermined trajectory with respect to the body and/or the platform in a force analysis module.

In one embodiment of the method according to the invention, the analytical determination of the natural vibration modes and/or the analytical determination of the acceleration forces and/or weights and/or torques is executed on the basis of inertial point masses.

In a further practically significant embodiment, the analytical determination of the natural vibrations of hexapods and the force analysis is executed as an analytic determination of the leg loads or forces of the legs of hexapods.

Furthermore, a drive control method of an arrangement of the type specified above is provided, which includes the aforesaid method and which is configured for a force analysis and/or vibration analysis before the start of a movement sequence and/or for analysing movement during a movement sequence of the bodies.

In an advantageous embodiment, the drive control method comprises a load change modelling, which is executed using output data of the force analysis module and optionally the vibration analysis module and as a result of a corresponding input by an operator or automatically in the event of a load change in the arrangement.

Within the framework of a further embodiment of the proposed drive control method, this comprises a storage of pre-calculated parameter tables in the manner of lookup tables in a storage unit and an execution of movement path corrections during the movement sequence of the bodies as a result the pre-calculated and stored parameter tables.

A drive control method of the type specified here is of practical importance within the framework of a control method of a machining arrangement in which a relative movement of a tool relative to a workpiece is controlled, in particular in a machining arrangement comprising a machine tool or an industrial robot.

Finally the invention also comprises a simulation method for movement path simulation of an arrangement of the type in question which comprises the steps of the aforesaid method for analysing movement and a simulation step which processes output values of the vibration analysis module and the force analysis module for simulating movement paths of the bodies or the platform with assigned bodies.

Advantages and expediencies of the invention are obtained from the following description of exemplary embodiments and aspects of the invention with reference to the appended figures. Of these:

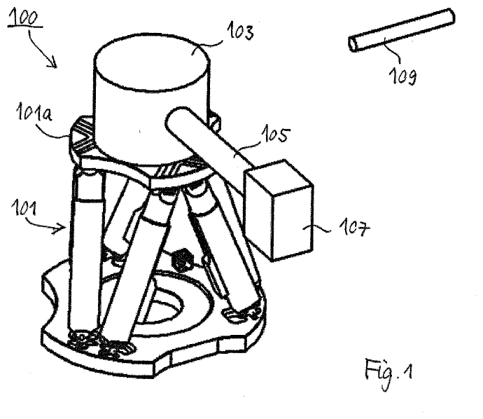

FIG. 1 shows a schematic diagram of a first exemplary arrangement to be analysed and controlled with the apparatus according to the invention for analysing movement, in the manner of a perspective view,

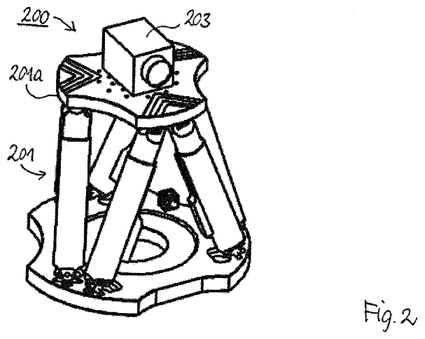

FIG. 2 shows a schematic diagram of a second exemplary arrangement to be analysed and controlled with the apparatus according to the invention for analysing movement, in the manner of a perspective view,

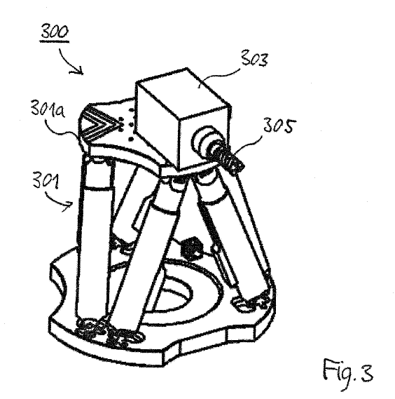

FIG. 3 shows a schematic diagram of a third exemplary arrangement to be analysed and controlled with the apparatus according to the invention for analysing movement, in the manner of a perspective view, and

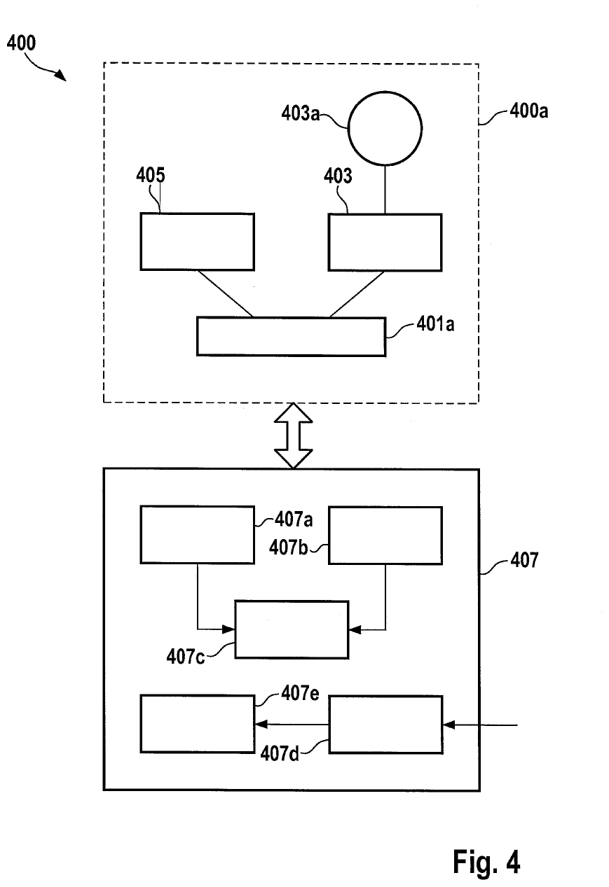

FIG. 4 shows a schematic diagram of a drive apparatus comprising an apparatus according to the invention for analysing movement according to an exemplary embodiment.

FIG. 1 shows as an exemplary embodiment of the invention a positioning arrangement 100, which comprises a hexapod 101 as carrier of a vacuum chamber 103, an x-ray scattering evaluation electronic system 107 and a support arm 105 connecting the vacuum chamber to the x-ray scattering evaluation electronic system, together with an x-ray beam source 109. Located in the vacuum chamber is a sample (not shown), possibly a heavy machine part, which is exposed to x-ray radiation from the x-ray beam source 109 for the purpose of material analysis and the x-ray radiation scattered by the sample is evaluated in the x-ray scattering evaluation electronic system 107.

The hexapod 101 therefore carries an arrangement of several loads, and specifically as external loads, the vacuum chamber 103, the sample located therein, the x-ray scattering evaluation electronic system 107 and the support arm 105, as well as in the form of internal loads a movable platform 101a of the hexapod and its own legs (not designated separately).

The internal loads, i.e. the platform 101a and the legs of the hexapod, can be neglected to a first approximation and in a computational examination.

The vacuum chamber acts primarily centrally due to its gravity and brings about inertial forces primarily with linear accelerations. In the case of the lever arm and electronics, in addition to gravity, first and foremost the torque is relevant, this being caused by the eccentric position which brings about a lever action. Furthermore, in the case of the support arm and evaluation electronics, mass moments of inertia are important here, which appear when support arm and evaluation electronics turn about hexapods and/or experience changes in their rotational movement.

The hexapod is controlled by a controller, which for example is controlled manually via a keypad or via a program running on the controller. Alternatively the controller can receive movement commands which are generated by a host computer in a program-controlled manner or are input on the host computer via a keypad.

In order to be able to take into account the loads, the loads mounted on the platform must be made known to the firmware. These data can be stored on a data carrier of the controller, transmitted individually for each body or transmitted computationally as a combined cumulative load.

The content of the boxes shown below designated as “inertia dataset” specifies the respective load completely in relation to its relevant properties here. Gravity, torques caused by lever action, all inertial forces and all gyroscopic forces which appear due to a constant rotational movement or an angular acceleration are completely described. The physical properties presented here by the inertial datasets which use inertia tensors can also be represented physically in a different manner.

1. Inertia dataset of the vacuum chamber

Inertia tensor/kg*m*m

| | | |
|---|---|---|
| 0.1 | 0.01 | 0.02 |
| 0.01 | 0.2 | 0.03 |
| 0.02 | 0.03 | 0.3 |

x/m y/m z/m Center of gravity

| | | |
|---|---|---|
| 0.0 | 0.0 | 0.1 |

mass/kg

120

2. Inertia dataset of the sample in the sample chamber

Inertia tensor/kg*m*m

| | | |
|---|---|---|
| 3.3 | 0.11 | 0.55 |
| 0.11 | 3.3 | 0.0 |
| 0.55 | 0.0 | 3.3 |

x/m y/m z/m Center of gravity

| | | |
|---|---|---|
| 0.0 | 0.0 | 0.2 |

mass/kg

220

3. Inertia dataset of the support arm

Inertia tensor/(kg*m*m)

| | | |
|---|---|---|
| 0.1 | 0.001 | 0.003 |
| 0.001 | 0.2 | 0.0 |
| 0.003 | 0.0 | 0.2 |

x/m y/m z/m Center of gravity

| | | |
|---|---|---|
| 0.0 | 0.80 | 0.2 |

mass/kg

220

4. Inertia dataset of the evaluation electronics

Inertia tensor/(kg*m*m)

| | | |
|---|---|---|
| 0.2 | 0.1 | 0.4 |
| 0.1 | 0.2 | 0.0 |
| 0.4 | 0.0 | 0.2 |

x/m y/m z/m Center of gravity

| | | |
|---|---|---|
| 0.0 | 1.6 | 0.2 |

mass/kg

90

According to the invention
new inertia data can be transmitted to the firmware
inertia data can be stored by the firmware
inertia data can be retrieved from the firmware

Stored inertia data are added to the calculation or removed from it.

With an arrangement of the type shown as an example in FIG. 1, various disadvantages of the prior art can be eliminated or avoided and specifically whereby a relevant software (firmware) is configured as follows:

On the firmware side a module is integrated which eliminates those positionings in which an overload of the legs can occur or a tilt can occur.

On the firmware side a module is integrated which can identify natural vibrations of the system in advance and eliminate those positionings in which undesirable natural vibrations can occur.

On the firmware side a module is integrated which adapts control parameters such that self-sustaining vibrations do not occur and transient processes are damped.

On the firmware side a module is integrated which limits the travel speeds (trajectory) in such a manner that the total dynamic loads which occur with all the other loads cannot produce an overload in the legs.

FIG. 2 shows in a schematic diagram as a further exemplary embodiment, an arrangement 200, and specifically a hexapod 201 with a platform 201a on which a sample 203 is mounted which is moved by the hexapod platform 201a. This arrangement is the subject of a highly dynamic precise movement simulation, where the sample 203 should follow a predefined trajectory (track curve).

Defined movement simulations can serve to subject technical devices to a permanent stressing due to its shaking movement or to test and validate image stabilization algorithms, to validate acceleration sensors and the like. Image stabilization algorithms play a role, for example, in consumer articles such as cameras and camcorders. Furthermore there are applications in which the orientation should follow a target, possibly whereby a laser source must be oriented highly dynamically.

As in the preceding example, the internal loads, i.e. those of the platform and the legs are eliminated from the analysis.

As is apparent, the following forces originate from the sample:
1. Its weight will be active centrally from its centre of gravity downwards
2. Inertial forces occur against a Cartesian acceleration
3. Gyroscopic forces occur due to rotational movements and rotational accelerations which must be led off via the hexapod legs.

The hexapod is controlled by a controller; a desired trajectory is stored in this or the path is controlled via a host computer.

In the event that an application requires a movement control within the framework of a target tracking, this is brought about currently within the framework of a closed control circuit combined with corresponding sensors.

In order to be able to take into account the loads, the loads mounted on the platform must be made known to the firmware. These data can be stored on a data carrier of the controller, transmitted individually for each body or transmitted computationally as a combined cumulative load.

The content of the following boxes shown below designated as “inertia dataset” here also specifies the respective load completely in relation to its relevant properties here. Gravity, torques caused by lever action, all inertial forces and all gyroscopic forces which appear due to a constant rotational movement or an angular acceleration are completely described. The physical properties presented by the inertial datasets which use inertia tensors can also be represented physically in a different manner.

The inertia dataset of the sample has the following representation

Inertia tensor/(kg*m*m)

| | | |
|---|---|---|
| 0.1 | 0.11 | 0.02 |
| 0.11 | 0.2 | 0.03 |
| 0.02 | 0.03 | 0.2 |

x/m y/m z/m Center of gravity

| | | |
|---|---|---|
| 0.0 | 0.0 | 0.1 |

mass/kg

2

According to the invention
new inertia data can be transmitted to the firmware
inertia data can be stored by the firmware
inertia data can be retrieved from the firmware

Stored inertia data are added to the calculation or removed from it.

With an arrangement of the type shown as an example in FIG. 2, various disadvantages of the prior art can be eliminated or avoided and specifically whereby a relevant software (firmware) is configured as follows:

On the firmware side a module is integrated which adapts parameters of the trajectory such that with the greatest possible dynamics the posture deviations are kept small.

On the firmware side a module is integrated which can identify natural vibrations of the system in advance and modifies the path control such that excitation of vibrations is avoided if necessary.

On the firmware side a module is integrated which adapts control parameters such that self-sustaining vibrations do not occur and transient processes are damped and the trueness of the path is increased. In particular, the fluctuating leg loads determined on the basis of the inertia data and the trajectory can be used as pre-control in the regulation of the leg length.

On the firmware side a module is integrated which limits or adapts the travel speeds (trajectory) in such a manner that the total dynamic loads which occur with all the other loads cannot produce an overload in the legs.

FIG. 3 shows another exemplary arrangement 300, the key element of which is again a hexapod 301 with a movable platform 301a. Mounted on this is a tool holder 303 in which a tool 305, possibly for machining a workpiece (not shown) is clamped. In the case of a tool change, a different load arrangement is obtained for the hexapod.

The forces acting on the hexapod here bring about a path deviation as a result of the intrinsic elasticity of the hexapod, which has a disadvantageous effect on the accuracy of the workpiece. The forces acting comprise inter alia weight forces and mass inertia forces. These forces in turn depend on the loads to be carried by the platform.

The respective tool influences the resonance frequency of the hexapod-tool system. Knowledge of the resonance frequency can be used to vary a path control and adapt control parameters, possibly even before commencement of the movement by using look-up tables so that the resonance frequency of the system is excited as little as possible and thus the formation of so-called chatter marks on the workpiece is counteracted.

If a cutting tool such as a milling head or a cutting blade is passed by a workpiece in a cutting manner, the path of the tool is shared with the workpiece. If the tool vibrates perpendicular to the movement direction and in the direction of the workpiece, i.e. executes a vibration, these vibrations are shared with the workpiece in the form of chatter marks.

In order to be able to take into account the loads, the loads mounted on the platform must be transmitted to the firmware. These data can be stored on a data carrier of the controller, transmitted individually for each body or transmitted computationally as a single load.

The “inertia dataset” again describes the respective load completely in relation to its relevant properties here. Gravity, torques caused by lever action, all inertial forces and all gyroscopic forces which appear due to a constant rotational movement or an angular acceleration are completely described. The physical properties presented here by the inertial datasets which use inertia tensors can also be represented equivalently in a different manner.

The inertia dataset of a tool holder 303 can be described in the following manner:

Inertia tensor/(kg*m*m)

| | | |
|---|---|---|
| 0.1 | 0.11 | 0.02 |
| 0.11 | 0.2 | 0.03 |
| 0.02 | 0.03 | 0.2 |

x/m y/m z/m Center of gravity

| | | |
|---|---|---|
| 0.0 | 0.0 | 0.1 |

mass/kg

2

The inertia dataset of a tool 305 can be described in the following manner:

Inertia tensor/(kg*m*m)

| | | |
|---|---|---|
| 0.1 | 0.11 | 0.02 |
| 0.11 | 0.2 | 0.03 |
| 0.02 | 0.03 | 0.2 |

x/m y/m z/m Center of gravity

| | | |
|---|---|---|
| 0.0 | 0.0 | 0.1 |

mass/kg

2

According to the invention, the inertia datasets of all tools and all tool holders can be held in readiness and activated or deactivated on each tool change.

According to the invention
new inertia data can be transmitted to the firmware
inertia data can be stored by the firmware
inertia data can be retrieved from the firmware
Stored inertia data are added to the calculation or removed from it.

With an arrangement of the type shown as an example in FIG. 3, various disadvantages of the prior art can be eliminated or avoided and specifically in particular whereby a relevant software (firmware) is configured as follows:

On the firmware side a module is integrated which adapts parameters of the trajectory such that with the greatest possible dynamics, posture deviations are kept small.

On the firmware side a module is integrated which can identify natural vibrations of the system in advance and modifies the path control such that excitation of vibrations is avoided if required.

On the firmware side a module is integrated which adapts control parameters such that self-sustaining vibrations do not occur and transient processes are damped and the trueness of the path is increased. In particular, the fluctuating leg loads determined on the basis of the inertia data and the trajectory can be used as pre-control in the regulation of the leg length.

On the firmware side a module is integrated which limits the travel speeds (trajectory) in such a manner that the total dynamic loads which occur with all the other loads cannot produce an overload in the legs.

On the firmware side a module is integrated which, in addition to the weight forces and inertia data obtained from the inertia datasets, also includes those forces and moments which are obtained from the machining process itself, possibly the resistance which the milling head experiences due to the tool during the machining.

FIG. 4 shows in the manner of a block diagram an exemplary drive apparatus 400 of an arrangement 400a comprising two bodies 403, 405 assigned to a platform 401a, of which the body 403 is provided with a drive 403a. The drive apparatus too comprise an analysis and control unit 407 for vibration analysis and influencing and force analysis and control and/or movement path analysis and control of the bodies 403, 405, wherein the analysis and control unit 407 comprises a vibration analysis module 407a and a force analysis module 407b which are configured to analyse vibrations or force on the basis of inertial point masses.

The analysis and control unit 407 further comprises a load change modelling unit 407 a connected on the input side to the vibration analysis module 407a and the force analysis module 407b which is configured to automatically model a load change in the case of a load change in the arrangement 400a. Furthermore the analysis and control unit 407 has a storage unit 407d for storing pre-calculated parameter tables and a movement path correction unit 407e connected to the storage unit for executing movement path corrections during the movement sequence of the bodies on the basis of the pre-calculated and stored parameter tables.

The functions of the components of the arrangement shown schematically in FIG. 4 are obtained for the person skilled in the art from the above explanations so that a more precise description can be dispensed with.

In addition, it is possible to execute the invention in a plurality of modifications of the examples shown here and aspects of the invention emphasized further above.

1. An apparatus for analysing movement (407) of an arrangement (400a) comprising a plurality of bodies (403; 405) assigned to a platform, of which at least one is provided with a drive (403a), in particular of the hexapod type or of the articulated-arm type, having means for vibration analysis and/or force analysis, characterized in that the apparatus in a modular structure comprises a vibration analysis module (407a) for analytical determination of natural vibration modes of the bodies and/or the platform with regard to at least one of the following variables: frequency, centre of rotation of the torsional component of the vibrations, axis of rotation of a torsional vibration, displacement vector of a Cartesian vibration, amplitude ratio of the vibrations with respect to one another and a force analysis module (407b) for analytical determination of the acceleration forces and/or weights and/or torques, occurring on a predetermined trajectory with respect to the body and/or the platform.

2. The apparatus (407) according to claim 1, wherein the vibration analysis module (407a) is configured for vibration analysis and the force analysis module (407b) is configured for force analysis, in each case based on inertial point masses.

3. The apparatus (407) according to claim 1, wherein the vibration analysis module (407a) is configured for analytical determination of the natural vibrations of hexapods and the force analysis module (407b) is configured as a leg load module for analytical determination of the leg loads or forces of the legs of hexapods.

4. The apparatus (407) according to claim 1, wherein the vibration analysis module (407a) is configured for analytical determination of the natural vibrations of an articulated arm and the force analysis module (407b) is configured as an articulated load module for determining the articulated loads or forces of the articulations of an articulated arm.

5. A drive apparatus (400) of an arrangement (400a) comprising a plurality of bodies (430; 405) assigned to a platform (401a), of which at least one is provided with a drive (403a), in particular of the hexapod type or articulated-arm type, having analysis and control means (407) for vibration analysis and influencing and force analysis and control and/or movement path analysis and control, wherein the analysis and control means comprise an apparatus according to claim 1 and are configured for a force analysis before starting a movement sequence and for analysing movement during a movement sequence of the body.

6. The drive apparatus (400) according to claim 5, wherein the analysis and control means (407) comprises a load change modelling unit (407c) which is connected on the input side to the force analysis module (407b) and optionally to the vibration analysis module (407a) and is configured for modelling a load case change as a result of a corresponding input by a user or automatically in the event of a load change in the arrangement (400a).

7. The drive apparatus (400) according to claim 5, wherein the analysis and control means (407) comprises a storage unit (407d) for storing pre-calculated parameter tables in the manner of lookup tables and a movement path correction unit (407e) connected to the storage unit for executing movement path corrections during the movement sequence of the bodies as a result of the pre-calculated and stored parameter tables.

8. The drive apparatus (400) according to claim 5, configured as a drive apparatus of a parallel or hybrid robot with at least one articulated arm which encloses a controller which is connected to outputs of the vibration analysis module (407a) and the force analysis module (407b) in which a controller parametrization is implemented as a result of output data of these modules.

9. A machining arrangement, in particular machine tool, having a drive apparatus (400) according to claim 5 for movement of a tool relative to a workpiece.

10. A simulation arrangement (407) for simulation of the movement paths of an arrangement comprising a plurality of bodies (403; 405) assigned to a platform (401a), of which at least one is provided with a drive (403a), in particular of the hexapod type or of the articulated-arm type, with an apparatus (407) according to claim 1 and a simulation processing unit, which processes output values of the vibration analysis module (407a) and the force analysis module (407b) for simulation of movement paths and if desired an allowed movement space of the body or the platform with assigned bodies.

11. A method for analysing movement of an arrangement (400a) comprising a plurality of bodies (403; 405) assigned to a platform (401a), of which at least one is provided with a drive (403a), in particular of the hexapod type or of the articulated-arm type, characterized in that the movement analysis comprises an analytical determination of natural vibration modes of the bodies and/or the platform with regard to at least one of the following variables: frequency, centre of rotation of the torsional component of the vibrations, axis of rotation of a torsional vibration, displacement vector of a Cartesian vibration, amplitude ratio of the vibrations with respect to one another in a vibration analysis module as well as an analytical determination of the acceleration forces and/or weights and/or torques, occurring on a predetermined trajectory with respect to the body and/or the platform in a force analysis module.

12. The method according to claim 11, wherein the analytical determination of the natural vibration modes and/or the analytical determination of the acceleration forces and/or weights and/or torques is executed on the basis of inertial point masses.

13. The method according to claim 11, wherein the analytical determination of the natural vibrations of hexapods and the force analysis is executed as an analytic determination of the leg loads or forces of the legs of hexapods.

14. A drive control method of an arrangement (400a) comprising a plurality of bodies (403; 405) assigned to a platform (401a), of which at least one is provided with a drive (403a), in particular of the hexapod type or of the articulated-arm type, which comprises a vibration analysis and influencing, force analysis and control and/or movement path analysis and control, which includes a method according to claim 11 and which is configured for force analysis before the start of a movement sequence and for analysing movement during a movement sequence of the bodies.

15. The drive control method according to claim 14, which comprises a load change modelling, which is executed using output values of the force analysis module (407b) and optionally the vibration analysis module (407a) and in the case of a corresponding input by an operator or automatically in the event of a load change in the arrangement (400a).

16. The drive control method according to claim 14, which comprises a storage of pre-calculated parameter tables in the manner of lookup tables in a storage unit (407d) and an execution of movement path corrections during the movement sequence of the bodies as a result of the pre-calculated and stored parameter tables.

17. The drive control method according to claim 14, configured as a drive control method of a parallel or hybrid robot with at least one articulated arm which include a controller parametrization as a result of output data of the vibration analysis module and the force analysis module.

18. A control method of a machining arrangement, in particular of a machine tool which comprises a drive control method according to claim 14 for controlling a relative movement of a tool relative to a workpiece.

19. A simulation method for movement path simulation of an arrangement (400a) comprising a plurality of bodies (403; 405) assigned to a platform (401a), of which at least one is provided with a drive (403a), in particular of the hexapod type or of the articulated-arm type, comprising the steps according to claim 11 and a simulation step which processes output values of the vibration analysis module (407a) and the force analysis module (407b) for simulating movement paths of the bodies or the platform with assigned bodies.
